(19) United States
(12) Patent Application Publication
(10) Pub. No.: US 2025/0174004 A1
(43) Pub. Date: May 29, 2025

(54) THREE-DIMENSIONAL OBJECT SHAPE ACQUISITION CHARACTERISATION AND CLASSIFICATION

(71) Applicant: UNIVERSITY OF NEWCASTLE UPON TYNE, Newcastle (GB)

(72) Inventors: Sadegh NADIMI SHAHRAKI, Newcastle (GB); Vasileios ANGELIDAKIS, Newcastle (GB)

(21) Appl. No.: 18/841,239

(22) PCT Filed: Mar. 22, 2023
(86) PCT No.: PCT/GB2023/050724

§ 371 Date: Aug. 23, 2024

(30) Foreign Application Priority Data
Mar. 23, 2022 (GB) 2204100.8

(51) Int. Cl. G06V 10/764; G06T 7/62; G06T 7/80; G06T 17/00; G06V 10/141; G06V 20/64; H04N 23/90

(52) U.S. Cl. CPC G06V 10/764; G06T 7/62; G06T 7/80; G06T 17/00; G06V 10/141; G06V 20/64; H04N 23/90

(57) ABSTRACT

There is disclosed an apparatus for capturing images of one or more objects (e.g. particles) to enable reconstruction and classification of the 3D shapes of the one or more objects, the apparatus comprising: an imaging array for capturing images of the one or more objects; and an object placement unit for containing or holding the one or more objects during the image capture; wherein the imaging array comprises a plurality of imaging devices (e.g. cameras) configured to simultaneously capture images of the one or more objects from a plurality of different angles. Two or more of the imaging devices may be configured in a polar arrangement and at least one imaging device may be configured orthogonally to the imaging devices configured in the polar arrangement. The object placement unit may comprises an acquisition chamber or tube, at least a part of which is located in the view field of the imaging devices, the one or more objects may be fed into the acquisition chamber or tube and fall under the effect of gravity through the view field of the imaging devices, and a drag field may be applied to the one or more objects to oppose the force of gravity on the one or more objects. The apparatus may further comprise one or more light sources (e.g. LEDs) for illuminating the one or more objects or for creating a bright field; and one or more light diffusers for diffusing the light emitted by the one or more light sources. The one or more objects may comprise one or more objects having at least one of the following scales: centimetre scale; millimetre scale; micron scale; sub-micron scale.

### FIELD

Certain examples of the present disclosure provide a technique for acquiring the three-dimensional (3D) shape of one or more objects, for example particles at the centimetre, millimetre, micron or sub-micron scale. Certain examples of the present disclosure provide a technique for characterising the 3D shape of the one or more objects. Certain examples of the present disclosure provide a technique for classifying the 3D shape of the one or more objects.

### BACKGROUND

The acquisition, characterisation and classification of the 3D shape of particles has numerous applications in various industries. For example, applications involving the analysis of dry particles include: mining, mineral and cement; food; fertilizers; glass beads; battery packaging materials; pharmaceuticals and medicine; additive manufacturing; civil engineering and building materials; and abrasives. Other applications include chemicals and petroleum; beverages; prosthetics; and biopharmaceuticals and drug discovery.

Typically, one or more images of a particle are captured. The shape of the particle is then constructed based on the captured images. The characterisation and classification of the particle is then performed based on the reconstructed shape.

One problem with conventional systems is that it is difficult to acquire images that enable full reconstruction of the 3D shape in a relatively straightforward manner. For example, some conventional techniques capture images in one plane/view only. However, this means that the shape characteristics in other planes/views cannot be reconstructed. Other conventional techniques rely on rotation of particles as they imaged to capture shape characteristics in different planes. For example, some systems image rotating particles as they fall through a medium, such as air, while other systems provide mechanical means, such as a rotating pedestal, to physically rotate a particle during image capture. However, it is difficult to control the rotation of falling particles: particles may rotate at different rates, may rotate too quickly, or may not rotate at all. Providing a mechanical means for physically rotating a particle adds cost and may not be suitable for simultaneously imaging a relatively large number of particles at the same time.

Accordingly, what is desired is a technique for acquiring the 3D shape of one or more objects, for example particles, for example to enable characterisation and/or classification of the objects.

The above information is presented as background information only to assist with an understanding of the present disclosure. No determination has been made, and no assertion is made, as to whether any of the above might be applicable as prior art with regard to the present disclosure.

### SUMMARY

It is an aim of certain examples of the present disclosure to address, solve, mitigate or obviate, at least partly, at least one of the problems and/or disadvantages associated with the related art, for example at least one of the problems and/or disadvantages mentioned herein. Certain examples of the present disclosure aim to provide at least one advantage over the related art, for example at least one of the advantages mentioned herein.

The present invention is defined in the independent claims. Advantageous features are defined in the dependent claims.

Embodiments or examples disclosed in the description and/or figures falling outside the scope of the claims are to be understood as examples useful for understanding the present invention.

Other aspects, advantages, and salient features of the present disclosure will become apparent to those skilled in the art from the following detailed description, which, taken in conjunction with the accompanying drawings, disclose examples of the present disclosure.

### BRIEF DESCRIPTION OF THE FIGURES

FIG. 1 schematically illustrates a system according to an example of the present disclosure;

FIGS. 2a and 2b are more detailed schematic diagrams of examples of the imaging module 101 of FIG. 1;

FIG. 3 illustrates an exemplary method according to the present disclosure; and

FIGS. 4a-d illustrate examples of acquisition, classification, characterisation and simplification, and characterising multi-sphere particles.

### DESCRIPTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made.

The terms and words used in this specification are not limited to the bibliographical meanings, but are merely used to enable a clear and consistent understanding of the present disclosure.

The same or similar components may be designated by the same or similar reference numerals, although they may be illustrated in different drawings.

Detailed descriptions of elements, features, components, structures, constructions, functions, operations, processes, characteristics, properties, integers and steps known in the art may be omitted for clarity and conciseness, and to avoid obscuring the subject matter of the present disclosure.

Throughout this specification, the words “comprises”, “includes”. “contains” and “has”, and variations of these words, for example “comprise” and “comprising”, means “including but not limited to”, and is not intended to (and does not) exclude other elements, features, components, structures, constructions, functions, operations, processes, characteristics, properties, integers, steps and/or groups thereof.

Throughout this specification, the singular forms “a”, “an” and “the” include plural referents unless the context dictates otherwise. For example, reference to “an object” includes reference to one or more of such objects.

By the term “substantially” it is meant that the recited characteristic, parameter or value need not be achieved exactly, but that deviations or variations, including for example, tolerances, measurement errors, measurement accuracy limitations and other factors known to those of skill in the art, may occur in amounts that do not preclude the effect the characteristic, parameter or value was intended to provide.

Throughout this specification, language in the general form of “X for Y” (where Y is some action, process, function, activity, operation or step and X is some means for carrying out that action, process, function, activity, operation or step) encompasses means X adapted, configured or arranged specifically, but not exclusively, to do Y.

Elements, features, components, structures, constructions, functions, operations, processes, characteristics, properties, integers, steps and/or groups thereof described herein in conjunction with a particular aspect, embodiment, example or claim are to be understood to be applicable to any other aspect, embodiment, example or claim disclosed herein unless incompatible therewith.

It will be appreciated that examples of the present disclosure can be realized in the form of hardware, software or any combination of hardware and software. Any such software may be stored in any suitable form of volatile or non-volatile storage device or medium, for example a ROM, RAM, memory chip, integrated circuit, or an optically or magnetically readable medium (e.g. CD, DVD, magnetic disk or magnetic tape).

Certain embodiments of the present disclosure may provide a computer program comprising instructions or code which, when executed, implement a method, system and/or apparatus in accordance with any aspect, claim, example and/or embodiment disclosed herein. Certain embodiments of the present disclosure provide a machine-readable storage storing such a program.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

As will be described in further detail below, various examples of the present disclosure provide a technique (e.g. method and an apparatus) for acquisition, characterisation and/or classification of objects (e.g. particles) in 3D.

In certain examples, the objects may be moving (e.g. flowing).

The technique may include simultaneous capturing of the dynamic objects by means of multiple imaging devices (e.g. cameras). The images captured by the imaging devices provide 2D projections/images of a 3D object. The positions of the imaging devices relative to the objects to be imaged and/or relative to each other may be known within a certain tolerance.

The technique may further comprise means for calibration of 2D images to remove any potential misalignment and/or blur caused by the movement of the dynamic objects. This dynamic calibration technique enables flexibility in the position of acquisition devices and frequency of acquisition (e.g. the number of frames per second).

The technique may further comprise means for adjusting the drag force applied to objects to control their moving velocity and the level of image blur.

The technique may further comprise means for processing and reconstruction of 2D images into 3D objects and characterisation and classification of their morphology. For example, classifications may include ‘flat’, ‘compact’, ‘bladed’ and ‘elongate’.

The simultaneous acquisition of the object morphology from different perspectives or views allows for a robust reconstruction of the morphology regardless of the orientation and dynamic rotation of the objects.

In certain examples, a continuous stream of objects may flow in effective “reduced gravity” facilitating the acquisition of their morphology. For example, deceleration of the objects' freefall may be facilitated by introducing a drag field against object movement, which opposes the natural gravity field. In certain examples, the drag field may be generated by one or more of the following non-limiting examples: air flow, liquid flow, acoustic stream, magnetic field.

The techniques disclosed herein may be applicable to objects of varying sizes from sub micron to few microns to several centimetres.

In certain examples, an object is allowed to move in the view axis of all the imaging devices simultaneously.

In certain examples, 2D projections may be calibrated to resolve any misalignment of the centre of the field of view. In certain examples, the 2D projections may be calibrated to resolve any misalignment of the imaging devices. In certain examples, the 2D projections may be aligned to a centre of a common field of view for all imaging devices.

In certain examples, 2D projections may be calibrated to resolve any blur by means of dynamic calibration objects moving in a flow. These may be objects of known size and/or shape covering some or all classification regions, which may include ‘flat’, ‘compact’, ‘bladed’ and ‘elongate’ for example.

In certain examples, certain characteristics (e.g. volume and surface area) of a 3D object may be calculated from its 3D reconstruction. In certain examples, 3D morphology descriptors may be calculated based on the 3D reconstruction.

Image processing and 3D reconstruction may be implemented in the form of a computer-based algorithm. The algorithm may identify an object, characterise the 3D morphology of the object, and classify the object based on the 3D morphology. The algorithm may then proceed to characterising the next object.

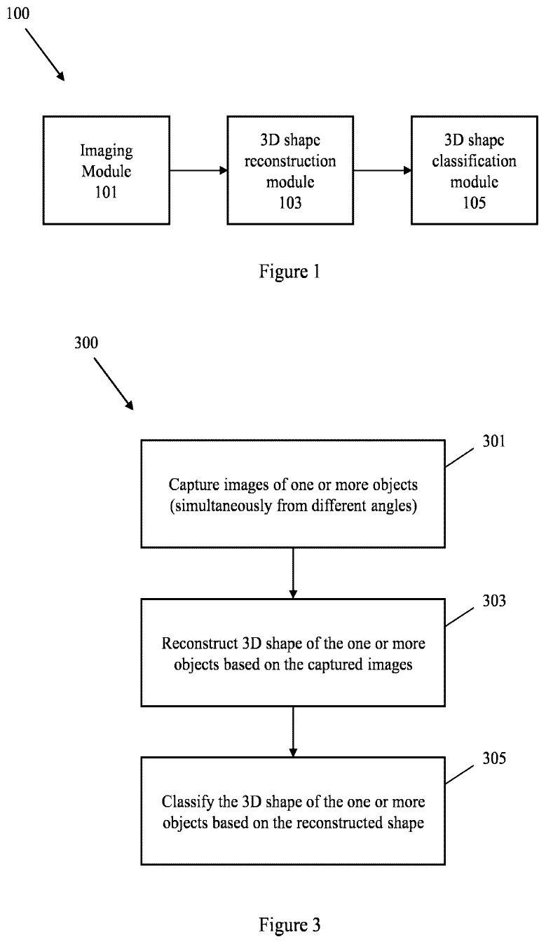

FIG. 1 schematically illustrates a system 100 according to an example of the present disclosure. As shown in FIG. 1, the system comprises an imaging module 101, a 3D shape reconstruction module 103, and a 3D shape classification module 105.

The imaging module 101 is configured for capturing images of one or more objects. In the present disclosure the objects are particles. However, the skilled person will appreciate that the present disclosure is not limited to particles and may be applied to other suitable types of object. Furthermore, in the present disclosure the objects may be any suitable scale, for example centimetre (cm) scale (e.g. 1-10 cm), millimetre (mm) scale (e.g. 1-10 mm), micron (m) scale (e.g. 1-1000 μm), or sub-micron scale (<1 μm). In certain examples, the techniques disclosed herein may be applied to objects from 100 μm to 50 mm. However, the skilled person will appreciate that the present disclosure is not limited to these scales and may be applied to objects/particles of any suitable scale or size. An example of an object at the cm scale is a ballast particle. An example of an object at the mm scale is an alumina or recycled glass particle. An example of an object at the micron scale is gas atomised steel powders for additive manufacturing. Examples of objects at the sub-micron scale include Magnesium Stearate for pharmaceutical tableting, and an iron pyrite particle, for example within a shale sample. More examples include all geomaterials in particulate form, chemicals, pharmaceutical powders, active pharmaceutical ingredients, foods, batteries, energy storage materials, spray drying materials, metal powders, mining and minerals.

The 3D shape reconstruction module 103 is configured for processing the images captured by the imaging module 101 to reconstruct the 3D shape of the object(s). In certain examples, the 3D shape reconstruction module 103 may be implemented in the form of software executed by a processor. Any suitable technique may be used for 3D reconstruction. One suitable technique is disclosed in Nadimi, S. and Fonseca, J., 2017. Single-grain virtualization for contact behaviour analysis on sand. Journal of Geotechnical and Geoenvironmental Engineering, 143(9), p. 06017010. The skilled person will appreciate that any suitable alternative technique may be used.

The 3D shape classification module 105 is configured for classifying and/or characterising the shape(s) of object(s) based on the reconstructed shape(s) determined by the 3D shape reconstruction module 103. In certain examples, the 3D shape classification module 103 may be implemented in the form of software executed by a processor, which may be the same processor as used in the 3D shape reconstruction module 103 or a different processor. Any suitable technique may be used for shape classification. One suitable technique is disclosed in Angelidakis, V., Nadimi, S., Utili, S. 2021. SHape Analyser for Particle Engineering (SHAPE): Seamless characterisation and simplification of particle morphology from imaging data. Computer Physics Communications 265, 107983. The skilled person will appreciate that any suitable alternative technique may be used.

Various examples of the present disclosure allow a variety of size and shape quantification, characterisation and classification. For example, various examples allow both particle size and shape characterisation and classification. Particle size may be characterised in terms of volume estimation, equivalent-volume sphere, inscribed and bounding sphere, bounding box, fitted ellipsoids, main particle dimensions. Particle shape may be characterised in terms of form (corresponding to larger particle features, for example sphericity, convexity, flatness, elongation, compactness) and roundness and angularity (corresponding to smaller particle features, for example sharpness of particle edges).

For example, classification of particle shape may be performed using one or more of the following classification systems:
Zingg (1935) Classification system
Sneed and Folk (1958) Classification System
Blott and Pye (2008) Classification System
Angelidakis et al. (2022) Classification System

Size and shape characterisation and classification may include the following examples:
Volume
Surface area
Inertia tensor
3D centroid
Sieve size (Equivalent sphere radius)
Inscribed sphere
Circumscribed sphere (multiple methods may be used to calculate it)
Fitted ellipsoid
Oriented bounding box (multiple methods may be used to calculate it)
Main particle dimensions (multiple methods may be used to calculate them)
Mean surface curvature
Gaussian surface curvature
Degree of true sphericity
Intercept Sphericity
Convexity
Flatness (multiple different indices may be used)
Elongation (multiple different indices may be used)
Compactness (multiple different indices may be used)
Irregularity
Roundness (multiple different indices may be used)
Angularity (multiple different indices may be used)

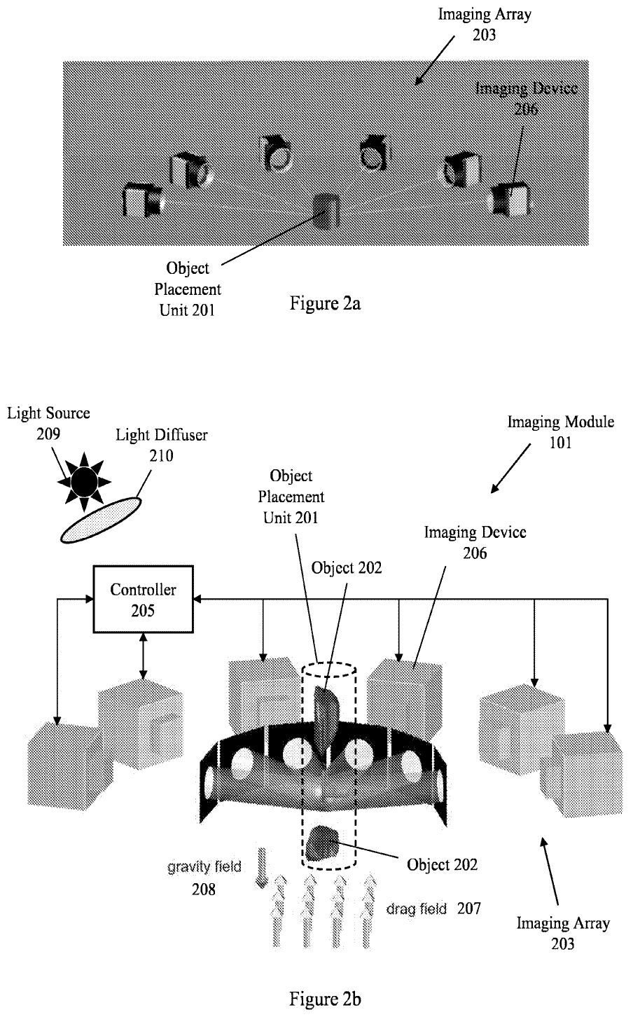

More detailed schematic diagrams of examples of the imaging module 101 of FIG. 1 are illustrated in FIGS. 2a and 2b. As shown in FIGS. 2a and 2b, the imaging module 101 comprises an object placement unit 201, an imaging array 203 and a controller 205.

The object placement unit 201 is a component configured to contain or hold one or more objects during image acquisition. For example, the one or more objects to be imaged are located in or on the object placement unit 201 during image acquisition. The objects may be static or may move during image acquisition depending on the configuration of the object placement unit 201.

In certain examples, the object placement unit 201 may be configured to hold an object in a static position during image acquisition. For example, the object placement unit 201 may comprise a platform or pedestal onto which an object is placed or fixed. The platform or pedestal may be transparent to allow images of the object to be captured from any direction. Alternatively, the object placement unit 201 may comprise a transparent fluid (gas or liquid) in which the objects are suspended, for example due to the viscosity of the fluid. In this case, the object placement unit 201 may comprise an acquisition chamber in which the fluid is contained. In another example, the object placement unit 201 may comprise a transparent solid substance in which one or more objects are encased.

In certain other examples, the object placement unit 201 may be configured such that an object moves through the object placement unit 201 during image acquisition. In one example, the object placement unit 201 may comprise a conveyer belt or similar moving platform. In another example, the object placement unit 201 may comprise a fluid (gas or liquid) through which an object travels during image acquisition. In this case, the object placement unit 201 may comprise an acquisition chamber, container or tube in which the fluid is contained. In one example, the object may fall through fluid contained in an acquisition chamber (where the fluid may be static) due to the effect of gravity. In another example, fluid may flow through a tube and draw the object with it. In these examples, one or more objects may be fed into the top of the acquisition chamber, or into one end of the tube, the objects then move through the imaging fields of the imaging devices, during which time the images are captured, and the objects may be collected at the bottom of the acquisition chamber or at the other end of the tube. This type of arrangement may allow multiple objects to be imaged more quickly and easily by gradually feeding the objects through the object placement unit, such that a continuous flow of objects are imaged and analysed.

The dynamic image-acquisition of free-falling particles typically requires high-speed imaging devices, due to high particle velocities, as the frame-per-second rate of conventional imaging devices is not adequate to capture the full particle inside a narrow field of view at the micro-meters scale.

Accordingly, certain examples of the present disclosure apply one or more techniques for the deceleration of otherwise relatively fast-moving dynamic objects. In particular, certain examples provide a drag field 207 acting opposite the moving direction of the objects. For example, the drag field may be deployed in a direction against the physical gravitational field 208, creating conditions of effective reduced gravity. The drag field may be realised using any suitable technique(s), for example one or more of air flow, magnetic field, acoustic stream, liquid suspension, increased viscosity (i.e. of the fluid through which the objects move), etc. The technique applied may be selected based on the analysed material, the size of the objects and their physical properties (e.g. density, magnetic behaviour, solubility etc). The intensity of the field may be adjustable, for example via a power-supply unit. This may allow the technique to be applied to objects of varying density and size. Providing the drag field allows for the imaging of dynamic objects by means of conventional imaging technologies, such as low-cost, industrial-grade or commercial optical cameras.

The velocity with which the objects fall through the chamber may be reduced using a number of techniques, for example by introducing a drag field. This avoids the need for high speed imaging devices, thereby reducing cost.

The imaging array 203 comprises a plurality of imaging devices 206 for capturing images of one or more objects located in or on the object placement unit 201 (e.g. in the acquisition chamber). An imaging device may comprise a camera (e.g. digital camera), although the skilled person will appreciate that any other suitable type of imaging device may be used. In certain examples, the imaging devices may be monochrome to reduce the volume of data, thereby facilitating image processing. However, the skilled person will appreciate that the present disclosure is not limited to monochrome imaging devices and that greyscale or colour imaging devices may be used in alternative examples. In the example illustrated in FIG. 2 there are six imaging devices. However, the skilled person will appreciate that any suitable number of cameras may be used, which may be more or less than six. In various examples of the present disclosure, the imaging array 203 is configured so that the imaging devices capture images simultaneously. In this way, different views of an object are captured at the same time point enabling easier 3D reconstruction of the object.

The locations and orientations of the imaging devices are configured such that images of the one or more objects are captured from a plurality of different angles. Preferably, each object should be viewable in the field of view of all imaging devices simultaneously.

Various configurations of the number, positions and orientations of the imaging devices may be used in various examples of the present disclosure and are not limited to the specific examples disclosed herein. In certain examples, the level of reconstruction errors for different arrangements may be compared to determine an optimal arrangement.

In certain examples, the number, positions and orientations of the imaging devices may be configured such that every part of the outer surface of an object is visible within at least one of the captured images. That is, the entire outer surface of the object is captured within the set of images. In certain examples, only a part of the outer surface of an object may be visible within a set of images captured at a certain time. In this case, the imaging devices may capture two or more images at different times, and rotation of the objects in the meantime results in parts of an object not visible in images captured at a first time becoming visible in images captured at a second time.

In certain examples, a set of (some or all) the imaging devices may be arranged to point towards substantially the same point. For example, the imaging devices may be arranged to lie on different points of the surface of a virtual sphere (or other suitable 3D shape) and may be arranged to point towards the centre of the virtual sphere. The imaging devices may be spread over the entire surface of the virtual sphere, or over only a part of the surface (e.g. a hemisphere). In certain examples, a first subset of imaging devices may be arranged to point towards a first point, and a second subset of imaging devices may be arranged to point towards a second point. More generally, two or more different subsets of imaging devices may be arranged to point towards two or more respective different points.

In certain examples, a set of (some or all) of the imaging devices may be arranged within the same plane. For example, the imaging devices may be arranged to lie on different points of the circumference of a virtual circle (or other suitable 2D shape) and may be arranged to point towards the centre of the virtual circle. The imaging devices may be spread over the entire circumference of the virtual circle, or over only a part of the circumference (e.g. a semi-circle). In certain examples, a first subset of imaging devices may be arranged in a first plane, and a second subset of imaging devices may be arranged in a second plane. More generally, two or more different subsets of imaging devices may be arranged in two different respective planes.

Various combinations of the above configurations may be applied in certain examples. For example, a set of imaging devices may be arranged in a plane while one or more imaging devices may be arranged outside that plane, for example at the endpoint of a line perpendicular to the plane.

In certain examples, the imaging devices do not need to be positioned at the same distance from the objects being imaged. When imaging devices are positioned at different distances from the objects, a calibration procedure may be performed, for example using one or more test objects of known size, to determine a scaling factor for each imaging device to compensate for the differences in distances between the imaging devices and the objects.

One exemplary technique for calibrating the optics of the system will now be briefly described. A set of calibration objects (e.g. spheres) of known size are fed in the apparatus before the analysed material. The calibration objects are used to calculate the pixel size for each imaging device. In certain examples, 10 calibration objects may be used, but the skilled person will appreciate that any other suitable number may be used. The calibration objects (e.g. spheres) are manufactured with high precision (e.g. diameter 6±0.002 mm), with a manufacturing tolerance lower than the resolution of the imaging devices (e.g. 0.0045 mm). Using multiple calibration objects (e.g. 10 precision spheres) improves the confidence interval of calibration compared to using a single static calibration object. This is because the real dimensions of the calibration objects are known with high precision, while each calibration object will typically fall in a different position inside the field of view, providing a more accurate estimation of the pixel size.

Another exemplary technique for calibrating the optics of the system after the pixel size has been calibrated will now be described. This may be put in place to optimise the arrangement of cameras and minimise blur during the imaging of dynamic particles. A set of calibration objects of known size and/or shape covering different classification regions is fed in the apparatus before the analysed material. In certain examples, 20 calibration objects may be used, for example 5 objects from each region of classification, but the skilled person will appreciate that any other suitable number may be used. The calibration objects (e.g. elliposids, superelipsoids, polyhedra) are manufactured with high precision (e.g. particle dimentions ranging from 0.02±0.001 mm to 0.2±0.001 mm), with a manufacturing tolerance lower than the resolution of the imaging devices.

The above dynamic calibration technique also provides a robust calibration of the employed frame-per-second rate, which is a key image acquisition parameter for dynamic objects. Knowing the exact dimensions of the calibration objects, the level of required drag is regulated so that the 3D reconstructions correspond to an error within an acceptable tolerance. Calibrating the frame-per-second rate is crucial in deciding the light intensity. Therefore, using the dynamic calibration technique described above ensures robustness of the imaging capabilities of the system.

The example illustrated in FIG. 2 comprises a fixed arrangement of six cameras positioned around a central column (e.g. acquisition chamber). The sample objects travel through the central column through the imaging field of the cameras. As the objects pass through the central column, the cameras simultaneously capture images of the objects to obtain image data for processing by the 3D shape reconstruction module 103.

As discussed above, any suitable number of imaging devices may be used in various examples. Three orthogonal cameras may provide limited morphological information, and relatively poor quality of 3D reconstruction. For example, concavities on the particle surface or smaller features of roundness and angularity may not be properly captured and characterised when using such an arrangement. Therefore, preferably, more than three cameras are used. Increasing the number of imaging devices typically improves fidelity of 3D reconstruction, but at the expense of increased cost. In certain examples, provided around six imaging devices may provide a reasonable balance between accuracy and cost. For example, an arrangement of six imaging devices, with five configured in a polar arrangement and one configured orthogonally to the others, allows high-quality 3D reconstruction, able to represent concave and finer particle features, associated with roundness and angularity for example.

The controller 205 is configured to control capture of the images by the imaging devices. For example, the controller may transmit a control signal to the imaging devices to control the imaging devices to simultaneously capture an image. In certain examples, the controller 205 may control each imaging device to capture two or more images at two or more respective times. The controller 205 is also configured to control storing of the images in a memory, and transmitting the images to the 3D shape reconstruction module 103. In this case, the controller may receive image data from each imaging device and store the image data in the memory. The controller may retrieve the image data from the memory when all images have been captured and transmit the image data to the 3D shape reconstruction module 103. Alternatively, the controller 205 may control the transfer of image data from the imaging devices to the 3D shape reconstruction module 103 as the images are captured. In this case, the image data may not be stored in the memory and may be processed in real-time (i.e. the shape reconstruction and classification of an object may be performed in a fraction of a second before moving to the next particle).

The system may be calibrated by using one or more test object, for example of known shape and/or size.

In certain examples, the imaging module 101 may further comprise one or more light sources 209 (e.g. LEDs) for illuminating the one or more objects, or for creating a bright field when a light source is in front of the imaging device to create contrast. The light sources 209 may be arranged so as to provide uniform illumination of the objects.

Various examples of the present disclosure rely on optical imaging, where consistent lighting conditions may be employed to ensure minimal calibration effort spent in camera settings. To achieve high frame-per-second rates, a relatively strong LED light-source may be needed during image acquisition for high-quality capturing of the particle morphology. This may create glare even for matte-textured particle surfaces. Accordingly, in certain examples, the imaging module 101 may comprise one or more light diffusers 210 for diffusing the light emitted by the light sources and to minimise glare from direct reflection of light on the particle surface. For example, the light diffusers may be placed between the light sources and the objects being imaged. This drastically minimises the image-processing efforts, enhancing automation of post-processing and 3D reconstruction.

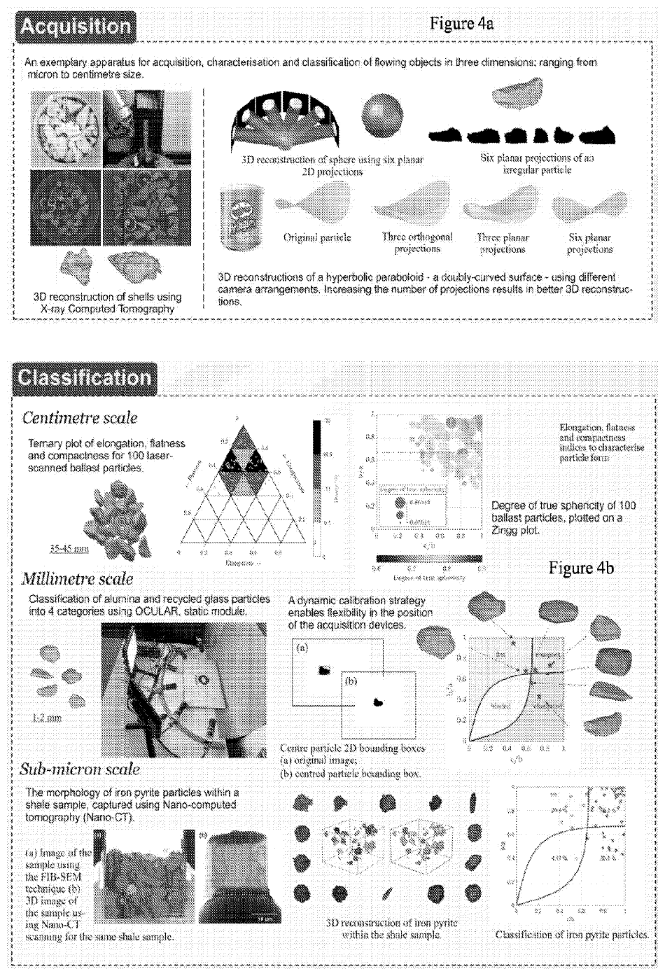

FIG. 3 illustrates an exemplary method 300 according to the present disclosure. In a first step 301, images of one or more objects are captured. The image capture may be performed according any suitable technique, for example any of the techniques disclosed herein. In a next step 303, the 3D shape of the one or more objects are reconstructed based on the captured images. The shape reconstruction may be performed according any suitable technique, for example any of the techniques disclosed herein. In a next step 305, the 3D shape of the one or more objects are classified based on the reconstructed shape. The classification may be performed according any suitable technique, for example any of the techniques disclosed herein.

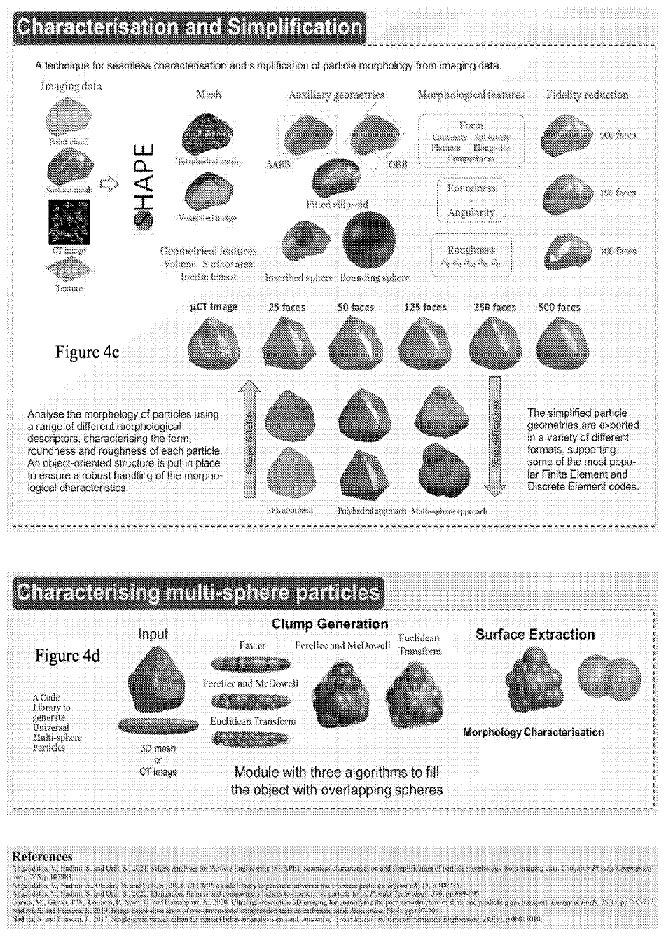

FIGS. 4a-d illustrate examples of acquisition, classification, characterisation and simplification, and characterising multi-sphere particles.

While the invention has been shown and described with reference to certain examples, it will be understood by those skilled in the art that various changes in form and detail may be made therein without departing from the scope of the invention, as defined by the appended claims.

1. An apparatus for capturing images of one or more objects (e.g. particles) to enable reconstruction and classification of the 3D shapes of the one or more objects, the apparatus comprising:
a imaging array for capturing images of the one or more objects; and
an object placement unit in or on which the one or more objects are located during the image capture;
wherein the imaging array comprises a plurality of imaging devices (e.g. cameras) configured to simultaneously capture images of the one or more objects from a plurality of different angles.

2. The apparatus according to claim 1, wherein the imaging array comprises more than three imaging devices (e.g. at least six imaging devices).

3. The apparatus according to claim 1, wherein two or more of the imaging devices are configured in a polar arrangement and at least one imaging device is configured orthogonally to the imaging devices configured in the polar arrangement.

4. An apparatus according to claim 1,
wherein the object placement unit comprises an acquisition chamber or tube, at least a part of which is located in the view field of the imaging devices,
wherein the one or more objects are fed into the acquisition chamber or tube and fall under the effect of gravity through the view field of the imaging devices, and
wherein a drag field is applied to the one or more objects to oppose the force of gravity on the one or more objects.

5. The apparatus according to claim 4, wherein the drag field is based on one or more of: air flow, liquid flow, magnetic field, acoustic stream, liquid suspension, increased viscosity.

6. The apparatus according to claim 1, further comprising one or more light sources (e.g. LEDs) for illuminating the one or more objects or for creating a bright field.

7. The apparatus according to claim 6, further comprising one or more light diffusers for diffusing the light emitted by the one or more light sources.

8. The apparatus according to claim 1, wherein the one or more objects comprise one or more objects having at least one of the following scales:
centimetre scale;
millimetre scale;
micron scale;
sub-micron scale.

9. A system comprising:
an imaging module for capturing images of one or more objects;
a 3D shape reconstruction module for reconstructing the 3D shape of the one or more objects based on the captured images; and
a 3D shape classification module for classifying the 3D shape of the one or more objects based on the reconstructed shape.

10. The system according to claim 9, further comprising one or more of:
a calibration framework for converting 2D acquisitions into the same scale and coordinates;
a calibration framework for aligning the images based on the real positions of the cameras; and
a calibration system for adjusting a drag system and speed of acquisition.

11. A method for capturing images of one or more objects (e.g. particles) to enable reconstruction and classification of the 3D shapes of the one or more objects, the method comprising simultaneously capturing images of the one or more objects from a plurality of different angles.

12. The method according to claim 11, further comprising one or more of:
reconstructing the 3D shape of the one or more objects based on the captured images; and
classifying the 3D shape of the one or more objects based on the reconstructed shape.

13. The method according to claim 12, further comprising performing a calibration procedure, wherein the calibration procedure comprises:
capturing images of one or more calibration objects of known sizes and/or shapes;

14. The method according to claim 13, wherein the calibration procedure further comprises determining a pixel size (e.g. a scale corresponding to an image pixel) of an imaging device based on the known sizes of the one or more calibration objects and the sizes (in pixels) of the one or more calibration objects appearing in an image captured by the imaging device.

15. The method according to claim 13, wherein the calibration procedure further comprises:
reconstructing the 3D shape of the one or more calibration objects;
determining the sizes and/or shapes of the one or more calibration objects based on the reconstructed shape;
comparing the determined sizes and/or shapes with the known sizes and/or shapes; and
determining one or more calibration factors based on a result of the comparison.

16. The method according to claim 11, further comprising applying a drag field to the one or more objects to oppose the force of gravity on the one or more objects.

17. The method according to claim 11, wherein the one or more objects and/or the one or more calibration objects comprise one or more objects and/or calibration objects having at least one of the following scales:
centimetre scale;
millimetre scale;
micron scale;
sub-micron scale.

18. The computer program comprising instructions which, when the program is executed by a computer or processor, cause the computer or processor to carry out a method according to claim 11.

19. The computer or processor-readable data carrier having stored thereon a computer program according to claim 18.
